(19) United States
(12) Patent Application Publication
(10) Pub. No.: US 2025/0103251 A1
(43) Pub. Date: Mar. 27, 2025

(54) INFORMATION PROCESSING DEVICE, INFORMATION PROCESSING METHOD, AND NON-TRANSITORY RECORDING MEDIUM

(71) Applicant: Hiroki KATAOKA, KANAGAWA (JP)

(72) Inventor: Hiroki KATAOKA, KANAGAWA (JP)

(21) Appl. No.: 18/820,277

(22) Filed: Aug. 30, 2024

(30) Foreign Application Priority Data
Sep. 21, 2023 (JP) 2023-156409

(51) Int. Cl. G06F 3/12

(52) U.S. Cl. CPC G06F 3/1205; G06F 3/1253

(57) ABSTRACT

An information processing device includes circuitry. The circuitry stores, in a memory, setting data related to setting of a device in association with openness data indicating whether the setting data is allowed to be opened to a plurality of users. The circuitry outputs a list of setting data that are stored in association with the openness data indicating that the setting data is allowed to be opened among the setting data stored in the memory to a terminal device. The circuitry outputs setting data identified from the list to the terminal device, the setting data to be used for generating setting data of another device.

### CROSS-REFERENCE TO RELATED APPLICATIONS

This patent application is based on and claims priority pursuant to 35 U.S.C. § 119(a) to Japanese Patent Application No. 2023-156409, filed on Sep. 21, 2023, in the Japan Patent Office, the entire disclosure of which is hereby incorporated by reference herein.

### BACKGROUND

### Technical Field

The present disclosure relates to an information processing device, an information processing method, and a non-transitory recording medium.

### Related Art

In the related art, a technique for printing devices is known in which, when a sheet attribute to be used is not registered, the registration of the sheet attribute is requested to the administrator via a network, and after the registration by the administrator, the updated sheet attribute is identified and the sheet setting for a tray is performed.

In the technique described above, when the administrator is requested to register the attribute, the administrator needs to regenerate the sheet attribute for the new sheet setting.

### SUMMARY

According to an embodiment of the present disclosure, an information processing device includes circuitry. The circuitry stores, in a memory, setting data related to setting of a device in association with openness data indicating whether the setting data is allowed to be opened to a plurality of users. The circuitry outputs a list of setting data that are stored in association with the openness data indicating that the setting data is allowed to be opened among the setting data stored in the memory to a terminal device. The circuitry outputs setting data identified from the list to the terminal device, the setting data to be used for generating setting data of another device.

According to an embodiment of the present disclosure, an information processing method includes storing, in a memory, setting data related to setting of a device in association with openness data indicating whether the setting data is allowed to be opened to a plurality of users. An information processing method includes outputting a list of setting data that are stored in association with the openness data indicating that the setting data is allowed to be opened among the setting data stored in the memory to a terminal device. An information processing method includes outputting setting data identified from the list to the terminal device, the setting data to be used for generating setting data of another device.

According to an embodiment of the present disclosure, a non-transitory recording medium stores a plurality of instructions which, when executed by one or more processors, causes the one or more processors to perform a method. The method includes storing, in a memory, setting data related to setting of a device in association with openness data indicating whether the setting data is allowed to be opened to a plurality of users. The method includes outputting a list of setting data that are stored in association with the openness data indicating that the setting data is allowed to be opened among the setting data stored in the memory to a terminal device. The method includes outputting setting data identified from the list to the terminal device, the setting data to be used for generating setting data of another device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a configuration of an information processing system;

FIG. 2 is a block diagram illustrating an example of a hardware configuration of an information processing device;

FIG. 3 is a diagram illustrating an example table of a setting data storing unit;

FIG. 4 is a block diagram illustrating a functional configuration of each device included in the information processing system;

FIG. 5 is a sequence diagram illustrating a first example of the processes performed by the information processing system;

FIG. 6 is a sequence diagram illustrating a second example of processes performed by the information processing system;

FIG. 7 is a flowchart illustrating a first example of the processes performed by the information processing device;

FIG. 8 is a flowchart illustrating a second example of the processes performed by the information processing device;

FIG. 9 is a flowchart illustrating a third example of the processes performed by the information processing device;

FIG. 10 is a diagram illustrating an example of a registration screen displayed on a terminal device;

FIG. 11 is a diagram illustrating an example of an acquisition screen displayed on the terminal device;

FIG. 12 is a diagram illustrating an example of a detail screen displayed on a terminal device;

FIG. 13 is a diagram illustrating an example of a comparison result screen displayed on the terminal device;

FIG. 14 is a diagram illustrating another example table of the setting data storing unit;

FIG. 15 is a diagram illustrating a first variation of the registration screen displayed on the terminal device; and

FIG. 16 is a diagram illustrating a second variation of the registration screen displayed on the terminal device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

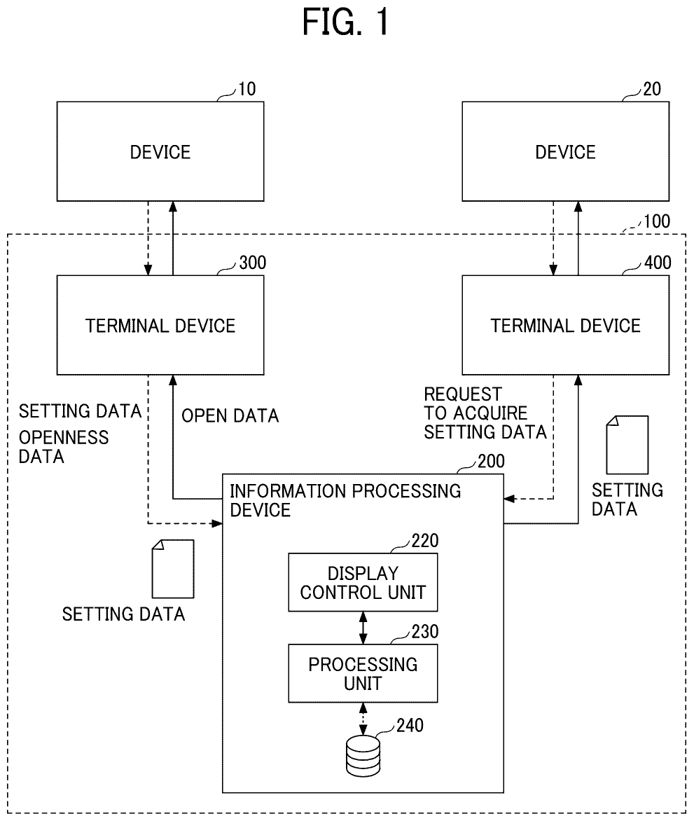

FIG. 1 is a diagram illustrating an example of a configuration of an information processing system.

An information processing system 100 according to the present embodiment includes an information processing device 200, and multiple terminal devices including a terminal device 300 and a terminal device 400. The information processing device 200, the terminal device 300, and the terminal device 400 are connected to each other via, for example, a network such as a local area network (LAN) or the Internet.

In the information processing system 100, the information processing device 200 includes a display control unit 220, a processing unit 230, and a setting data storing unit 240.

The display control unit 220 controls display on the terminal device 300 and the terminal device 400. The processing unit 230 stores setting data generated at each of the terminal devices 300 and 400 in the setting data storing unit 240.

The setting data is data related to the setting of one or more devices used by a user of the terminal device 300 or a user of the terminal device 400. The setting data is generated by the terminal device 300 or 400 according to information input by the user of the terminal device 300 or 400. In the example illustrated in FIG. 1, the user of the terminal device 300 uses a device 10 and the user of the terminal device 400 uses a device 20. The user of the terminal device 300 or 400 may use multiple devices.

The devices 10 and 20 are devices which are connected to the terminal devices 300 and 400, respectively, via the network. Examples of the devices 10 and 20 include image forming devices, microfabrication devices, and inspection devices. Each of the devices 10 and 20 may be any device that operates according to the setting data including values set by the user.

The setting data for the device is associated with openness data for the device, which indicates whether the setting data is allowed to be opened to other users other than the user of the terminal device that communicates with the device.

The openness data is transmitted together with the setting data from the terminal device to the information processing device 200 and stored together with the setting data in the setting data storing unit 240.

In the example illustrated in FIG. 1, the setting data and the openness data each generated by the user of the terminal device 300, and the setting data and the openness data each generated by the user of the terminal device 400 may be stored in the setting data storing unit 240 of the information processing device 200.

An overview of an example operation performed by the information processing system 100 is described below. In the following description, it is assumed that the setting data and the openness data of the device 10 generated at the terminal device 300 are stored in the setting data storing unit 240 of the information processing device 200. According to an instruction from the user, the terminal device 400 acquires the setting data stored in the setting data storing unit 240 and sets the setting data to the device 20.

In the information processing system 100, when the setting data of the device 10 is generated, the terminal device 300 allows the user to input information regarding openness data, which indicates whether the generated setting data is allowed to be opened. The terminal device 300 transmits the setting data and the openness data to the information processing device 200. When the information processing device 200 receives the setting data and the openness data from the terminal device 300, the processing unit 230 of the information processing device 200 stores the setting data and the openness data in the setting data storing unit 240. When the newly stored setting data in the setting data storing unit 240 is setting data which is allowed to be opened, the information processing device 200 transmits a list of setting data including the newly stored setting data to the terminal devices 300 and 400.

When the information processing device 200 receives a request for acquisition of the setting data identified from the list from the terminal device 400, the processing unit 230 of the information processing device 200 transmits the identified setting data to the terminal device 400.

As described above, in the present embodiment, the setting data of the device 10 generated by the user of terminal device 300 is provided to the terminal device 400 for use by the user of the terminal device 400. Therefore, in the present embodiment, the user of the terminal device 400 can generate setting data of the device 20 using the setting data of the device 10 acquired from the information processing device 200.

Therefore, in the present embodiment, the user of the terminal device 400 can use setting data of another device (for example, the device 10) generated by the user of the terminal device 300 to generate setting data of the device 20, instead of newly generating setting data of the device 20 of the user, thereby reducing the workload required to acquire the setting data.

In the example illustrated in FIG. 1, the information processing device 200 is a single computer. However, the information processing device 200 is not limited to a single computer. The information processing device 200 may be implemented by multiple computers. In the present embodiment, the setting data storing unit 240 is included in the information processing device 200. Alternatively, the setting data storing unit 240 may be partly or entirely included in an external device that can communicate with the information processing device 200.

In the example illustrated in FIG. 1, the terminal devices included in the information processing system 100 are the terminal devices 300 and 400. However, the terminal devices are not limited to the terminal devices 300 and 400. The number of terminal devices included in the information processing system 100 may be any number. In the example illustrated in FIG. 1, the devices 10 and 20 are connected to the terminal devices 300 and 400, respectively. However, multiple devices may be connected to each of the terminal devices 300 and 400. Any number of devices may be connected to each of the terminal devices 300 and 400.

In FIG. 1 and the following description, it is assumed that the terminal device 300 stores the setting data in the information processing device 200, and the terminal device 400 acquires the setting data from the information processing device 200.

Alternatively, in the information processing system 100, the terminal device 400 may store the setting data in the information processing device 200, and the terminal device 300 may acquire the setting data from the information processing device 200. Alternatively, the terminal device that stores the setting data in the information processing device 200 and the terminal device that acquires the setting data from the information processing device 200 may be the same terminal device. The setting data may be stored and acquired by one or more terminal devices according to the user preference.

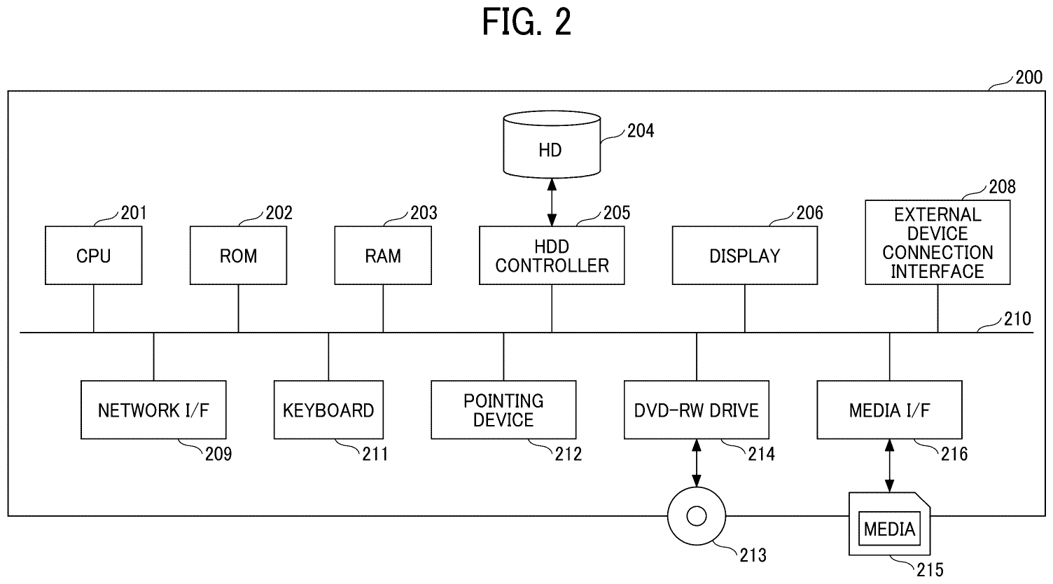

A hardware configuration of the information processing device 200 according to the present embodiment is described below with reference to FIG. 2. FIG. 2 is a block diagram illustrating an example of a hardware configuration of the information processing device 200.

As illustrated in FIG. 2, the information processing device 200 includes a central processing unit (CPU) 201, a read only memory (ROM) 202, a random access memory (RAM) 203, a hard disk (HD) 204, a hard disk drive (HDD) controller 205, a display 206, an external device connection interface (I/F) 208, a network I/F 209, a bus line 210, a keyboard 211, a pointing device 212, a digital versatile disc rewritable (DVD-RW) drive 214, and a media I/F 216.

The CPU 201 controls the overall operation of the information processing device 200. The ROM 202 stores a program such as an initial program loader (IPL) used for activating the CPU 201. The RAM 203 is used as a work area for the CPU 201. The HD 204 stores various data such as a control program. The HDD controller 205 controls reading and writing of various data from and to the HD 204 under control of the CPU 201. The display 206 displays various types of information such as a cursor, menu, window, character, or image. The external device connection I/F 208 is an interface circuit that connects the information processing device 200 to various external devices. Examples of the external devices include, but are not limited to, a universal serial bus (USB) memory and a printer.

The network I/F 209 is an interface circuit that enables communication of data through a communication network. The bus line 210 is an address bus or a data bus, which electrically connects the elements illustrated in FIG. 2 such as the CPU 201.

The keyboard 211 serves as an input device and is provided with multiple keys that allow a user to input characters, numerals, or various instructions. The pointing device 212 also serves as an input device and allows a user to select or execute a specific instruction, select a target for processing, or move a cursor being displayed. An example of the pointing device 212 is a mouse. The DVD-RW drive 214 controls reading and writing of various data from and to a DVD-RW 213, which is an example of a removable storage medium. The removable storage medium is not limited to the DVD-RW and may be a digital versatile disc-recordable (DVD-R), for example. The media I/F 216 controls reading and writing (storing) of data from and to a storage medium 215 such as a flash memory.

The hardware configuration of each of the terminal devices 300 and 400 is substantially the same as that of the information processing device 200, and the description thereof is omitted.

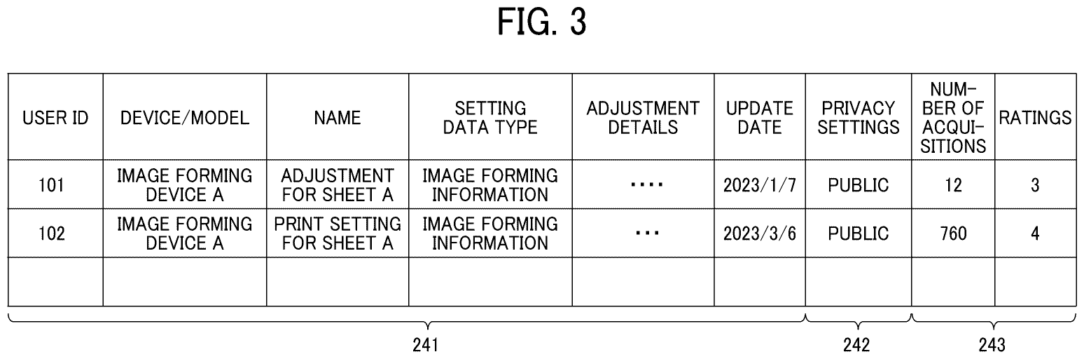

A description is now given of the setting data storing unit 240 according to the present embodiment, with reference to FIG. 3. FIG. 3 is a diagram illustrating an example table, which is stored in the setting data storing unit.

The setting data storing unit 240 may be implemented by, for example, the HD 204.

The data stored in the setting data storing unit 240 according to the present embodiment includes setting data 241, openness data 242, and rating data 243 that are associated with each other.

The setting data 241 includes user ID, device/model, name, setting data type, adjustment details, and update date as information items for each of the setting data stored in the information processing device 200. The openness data 242 includes privacy settings as an information item. The rating data 243 includes the number of acquisitions and ratings as information items.

The value of the item “user ID” is one example of identification information for identifying the user who has generated the setting data.

In the present embodiment, instead of “the user ID,” identification information that is uniquely assigned to the setting data may be used to identify the setting data. For example, the item “name,” which is uniquely assigned to the setting data, may be used as the identification information for identifying the setting data.

The value of the item “device/model” indicates information for identifying the device corresponding to the setting data.

In the example illustrated in FIG. 3, a name of the device and a name of the model of the device are used as information for identifying a particular device. The information for identifying a device is not limited to the example illustrated in FIG. 3, such that any identification information individually assigned to the device may be used.

The value of the item “name” indicates the name of the setting data. The name may be set by the user who has generated the setting data. The value of the item “setting data type” indicates the type or process of the device to which the setting data is applied. The value of the item “adjustment details” indicates the specific setting details such as various set values. The item “update date” indicates the date when the setting data is updated.

The value of the item “privacy settings” indicates whether the setting data is allowed to be opened. Specifically, the setting data whose value is “public” for the item “privacy settings” indicates that the setting data is allowed to be opened, and the setting data whose value is “private” for the item “privacy settings” indicates that the setting data is prohibited to be opened.

The value of the item “number of acquisitions” indicates the number of times the corresponding setting data has been acquired by one or more users in the past. The value of the item “ratings” indicates the result of collection of ratings from users who have acquired the corresponding setting data.

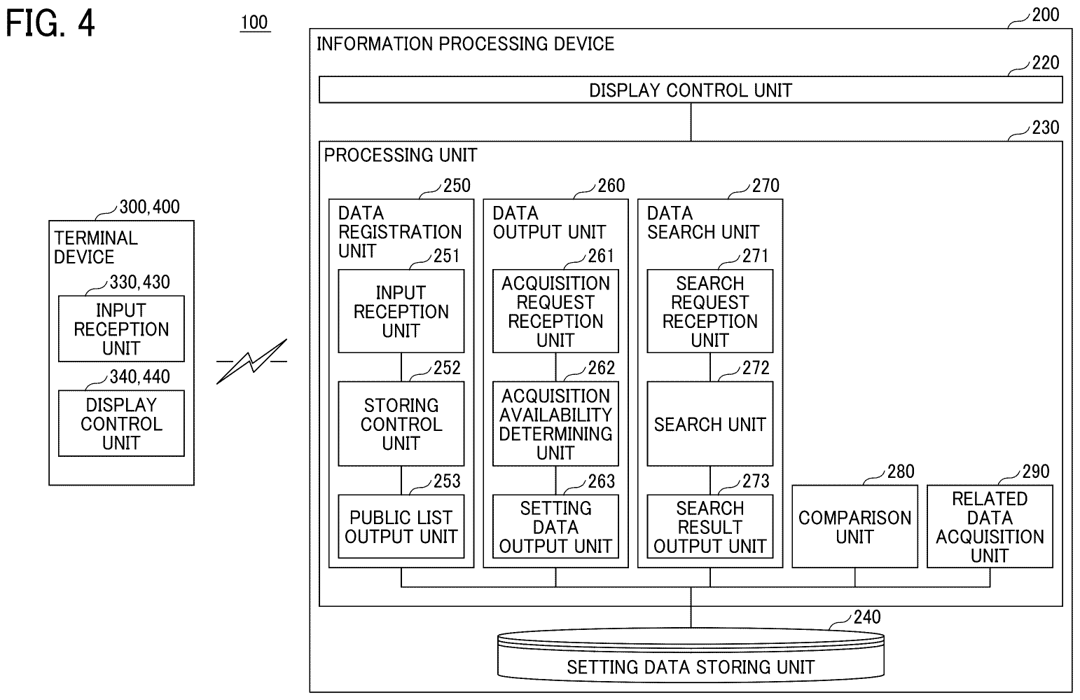

A functional configuration of each device included in the information processing system 100 is described below with reference to FIG. 4. FIG. 4 is a block diagram illustrating a functional configuration of each device included in the information processing system 100.

The terminal devices 300 and 400 according to the present embodiment have functional configurations similar to each other. The terminal device 300 includes an input reception unit 330 and a display control unit 340. The terminal device 400 includes an input reception unit 430 and a display control unit 440.

The input reception units 330 and 430 receive input by a user operation on screens displayed on the display control unit 340 and 440, respectively. The input reception units 330 and 430 are each implemented by the CPU 201, which operates in cooperation with the keyboard 211 and the pointing device 212.

The display control units 340 and 440 each display a screen for storing setting data in the information processing device 200 and a screen for acquiring setting data on displays of the terminal devices 300 and 400. The display control units 340 and 440 are each implemented by the CPU 201, which operates in cooperation with the display 206.

The information processing device 200 according to the present embodiment includes the display control unit 220 and the processing unit 230. The display control unit 220 and the processing unit 230 are implemented by the CPU 201 of the information processing device 200 reading and executing a program stored in, for example, the ROM 202 or the HD 204.

The display control unit 220 provides instructions to the terminal devices 300 and 400 to display various screens.

The processing unit 230 includes a data registration unit 250, a data output unit 260, a data search unit 270, a comparison unit 280, and a related data acquisition unit 290.

In the present embodiment, each of the data registration unit 250, the data output unit 260, and the data search unit 270 executes processing independently in response to requests from the terminal devices 300 and 400 that communicate with the information processing device 200.

The data registration unit 250 stores the setting data in the processing unit 230, such as a memory in the processing unit 230. The data registration unit 250 includes an input reception unit 251, a storing control unit 252, and a public list output unit 253. The input reception unit 251 receives input of setting data and openness data generated in the terminal device 300. In other words, the input reception unit 251 receives a request from the terminal device 300 to store setting data, together with the setting data and the openness data.

The storing control unit 252 stores the setting data and the openness data received by the input reception unit 251 in the setting data storing unit 240. When the setting data stored in the setting data storing unit 240 is updated, the public list output unit 253 outputs to the terminal devices 300 and 400 a notification indicating that the setting data allowed for being opened have been updated. Specifically, the public list output unit 253 outputs a list of setting data that are allowed to be opened.

The data output unit 260 outputs the setting data identified by the terminal device 400 to the terminal device 400. The data output unit 260 includes an acquisition request reception unit 261, an acquisition availability determining unit 262, and a setting data output unit 263.

The acquisition request reception unit 261 receives a request for acquisition of the setting data from the terminal device 400.

The acquisition availability determining unit 262 determines whether the terminal device 400 is allowed to acquire the setting data for which the request for acquisition has been received. The setting data output unit 263 outputs the setting data to the terminal device 400 that is allowed to acquire the setting data.

The data search unit 270 searches setting data stored in the setting data storing unit 240 in response to a request for search for setting data from the terminal device 400, and outputs a search result to the terminal device 400.

The data search unit 270 includes a search request reception unit 271, a search unit 272, and a search result output unit 273. The search request reception unit 271 receives a request for search for the setting data from the terminal device 400. The search unit 272 searches the setting data storing unit 240 in response to the request for search. The search result output unit 273 outputs the result of search performed by the search unit 272 to the terminal device 400.

For example, when the comparison unit 280 outputs setting data to the terminal device 400, the comparison unit 280 acquires from the terminal device 400 the setting data of the image forming device (an example of the device) connected to the terminal device 400, and compares the output setting data with the setting data acquired from the terminal device 400. The display control unit 220 may cause the terminal device 400 to display the result of comparison.

The related data acquisition unit 290 may acquire setting data related to the setting data selected at the terminal device 400. The display control unit 220 may cause the terminal device 400 to display the acquired setting data.

The image forming device connected to the terminal device 400 is, in other words, the image forming device associated with the user ID of the user using the terminal device 400.

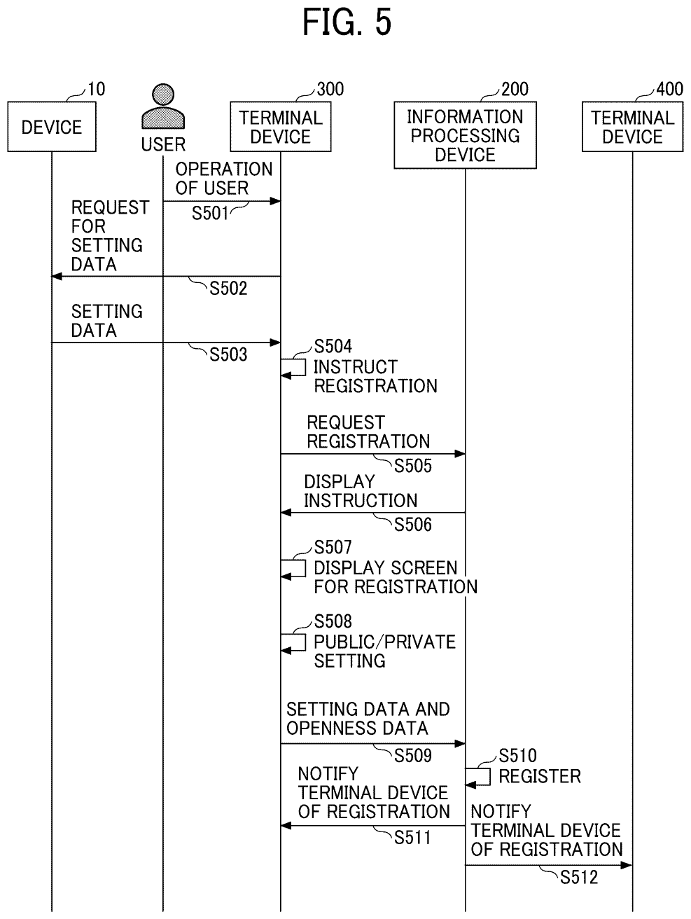

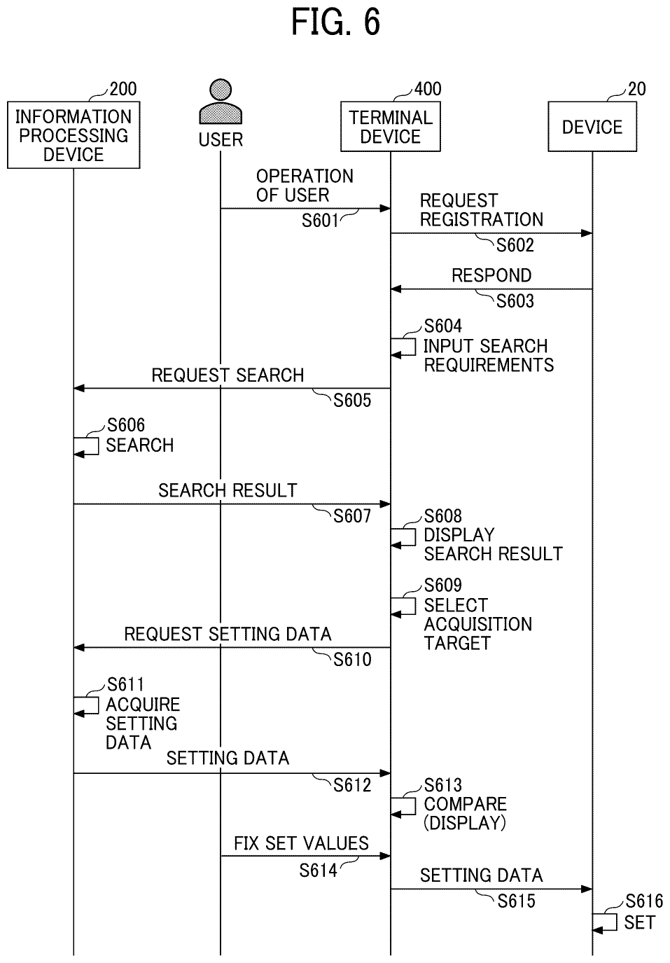

Processes performed by the information processing system 100 according to the present embodiment are described below with reference to FIG. 5 and FIG. 6. A process of storing the setting data and the openness data of the device 10 is described below with reference to FIG. 5. A process of setting the setting data retrieved from the setting data storing unit 240 to the device 20 is described below with reference to FIG. 6. In FIG. 5 and FIG. 6, the device 10 is an image forming device A and the device 20 is an image forming device B.

FIG. 5 is a sequence diagram illustrating a first example of the processes performed by the information processing system 100.

In step S501, the input reception unit 330 of the terminal device 300 receives an operation from the user, which instructs to acquire setting data of the device 10.

In step S502, the network I/F 209 of the terminal device 300 transmits to the device 10 a request for acquisition of the setting data currently set in the device 10 via the network. In step S503, the network I/F 209 of the terminal device 300 acquires the setting data from the device 10 via the network.

In step S504, the input reception unit 330 of the terminal device 300 receives an operation from the user, instructing registration (storing) of the setting data of the device 10 to the information processing device 200. In step S505, the network I/F 209 of the terminal device 300 transmits a request for registration of the setting data to the information processing device 200 via the network.

In response to the request for registration, in step S506, the display control unit 220 of the information processing device 200 transmits an instruction to display a registration screen for registering the setting data to the terminal device 300.

In response to the instruction to display the registration screen, in step S507, the display control unit 340 of the terminal device 300 displays the screen for registration on the display 206. In step S508, the input reception unit 330 of the terminal device 300 receives a public/private setting of the setting data of the device 10 via the screen for registration. In step S509, the network I/F 209 of the terminal device 300 transmits, with a request for registration, the setting data and the openness data of the device 10 to the information processing device 200.

In response to a request for registration of the setting data and the openness data of the device 10 from the terminal device 300, in step S510, the data registration unit 250 of the information processing device 200 registers (stores) the setting data and the openness data of the device 10 in the setting data storing unit 240. Details of the action of step S510 will be described below.

In step S511 and S512, the network I/F 209 of the information processing device 200 notifies the terminal device 300 and the terminal device 400, respectively, of the registration of the setting data and the openness data by the data registration unit 250.

The above is a description of the process of storing the setting data and the openness data of the device 10 in the setting data storing unit 240 of the information processing device 200.

FIG. 6 is a sequence diagram illustrating a second example of the processes performed by the information processing system 100.

In step S601, the input reception unit 430 of the terminal device 400 receives an operation from the user, instructing a start of setting for the device 20. In step S602, the network I/F 209 of the terminal device 400 transmits a request for acquisition of the setting data currently set to the device 20. In step S603, the network I/F 209 of the terminal device 400 acquires the setting data from the device 20.

In step S604, the display control unit 440 of the terminal device 400 displays a search screen for inputting search parameters on the display 206, and receives input of search parameters for the setting data to be acquired from the information processing device 200. In step S605, the terminal device 400 transmits a search request including the search parameters to the information processing device 200. The search parameters input may be, for example, search parameters to search for existing setting data used to generate the setting data of the device 20.

In response to the search request, in step S606, the data search unit 270 of the information processing device 200 searches the setting data storing unit 240 based on the search parameters. In step S607, the information processing device 200 transmits the search result to the terminal device 400. Details of the action of step S606 will be described below.

In response to the search result, in step S608, the display control unit 440 of the terminal device 400 displays a search result screen including the search result on the display 206. In step S609, the terminal device 400 receives selection of setting data from the search result displayed on the search result screen. In step S610, the terminal device 400 transmits a request for acquisition of the selected setting data to the information processing device 200.

In response to the request for acquisition of the setting data, in step S611, the data output unit 260 of the information processing device 200 acquires the requested setting data from the setting data storage unit 240. In step S612, the network I/F 209 of the information processing device 200 transmits the acquired setting data to the terminal device 400. It is assumed that the setting data of the device 10 is acquired. Details of the action of step S611 will be described below.

In response to reception of the setting data of the device 10, in step S613, the display control unit 440 of the terminal device 400 displays the setting data of the device 10 and the current setting data of the device 20 to allow the user to compare these setting data.

In step S614, the input reception unit 430 of the terminal device 400 receives an operation from the user to determine set values to be set for the device 20. In step S615, the network I/F 209 of the terminal device 400 transmits an instruction to set the setting data with the set values that are determined to the device 20. In response to the setting instruction from the terminal device 400, in step S616, the setting data is set to the device 20.

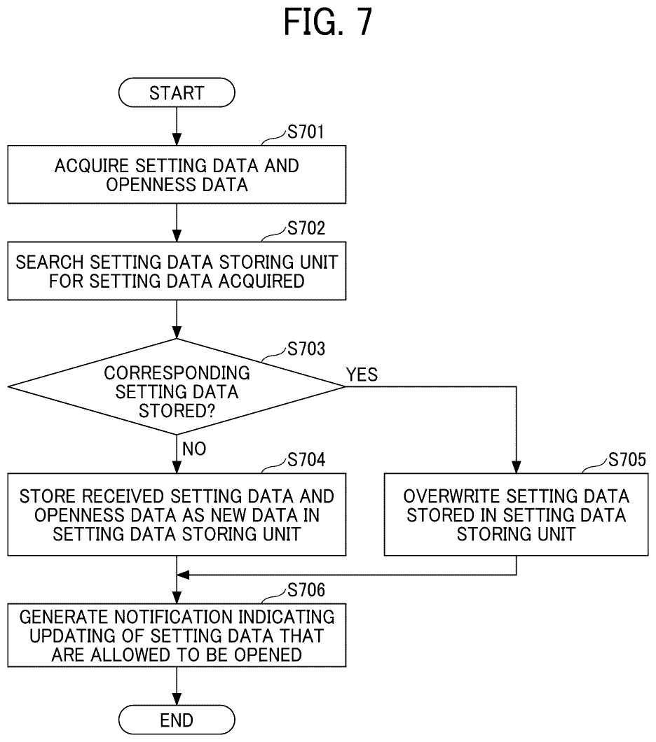

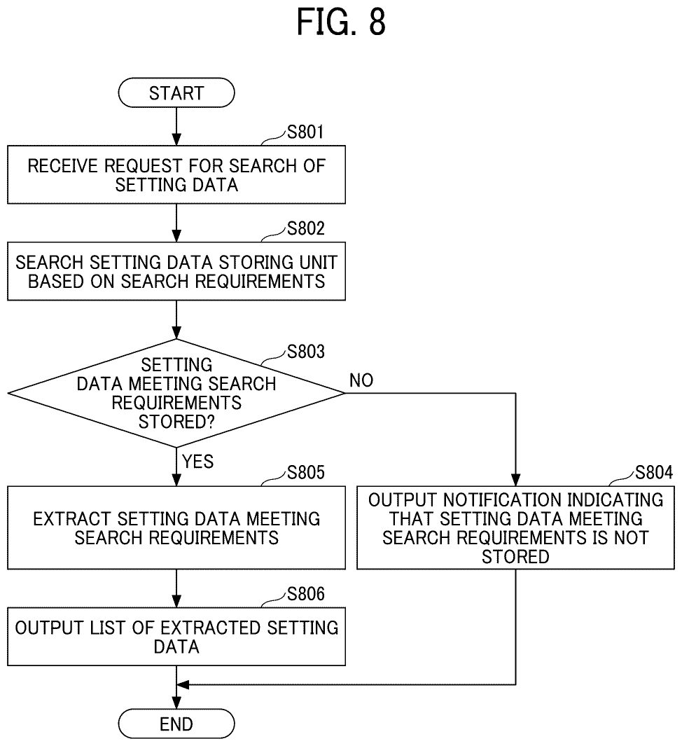

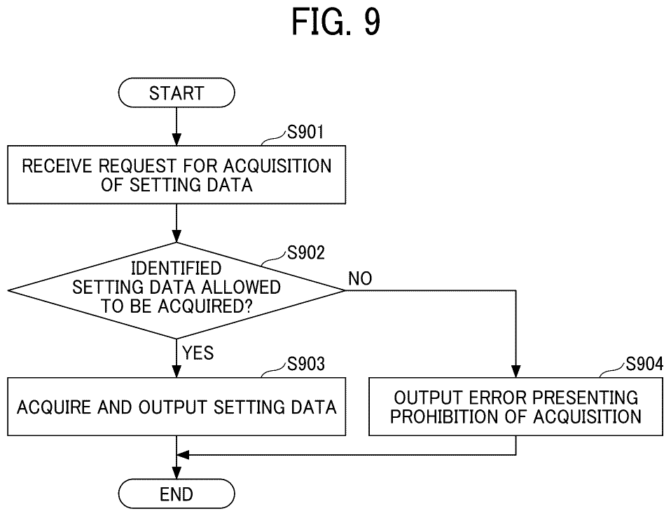

Referring to FIG. 7, FIG. 8, and FIG. 9, processes performed by the information processing device 200 according to the present embodiment is described. FIG. 7 is a flowchart illustrating a first example of the processes performed by the information processing device 200. FIG. 7 illustrates the details of the action of step S510 in FIG. 5. In other words, FIG. 7 illustrates the process performed by the data registration unit 250 of the processing unit 230 of the information processing device 200.

The data registration unit 250 performs the process illustrated in FIG. 7 each time the data registration unit 250 receives the request for registration of the setting data and the openness data from the terminal device 300 that communicates with the information processing device 200.

In step S701, the input reception unit 251 of the data registration unit 250 acquires the setting data and the openness data received from the terminal device 300.

In step S702, the storing control unit 252 of the data registration unit 250 searches the setting data storing unit 240, which corresponds to the setting data acquired in step S701. In step S703, the storing control unit 252 determines whether the corresponding setting data is stored in the setting data storing unit 240. Specifically, the storing control unit 252 determines whether the setting data corresponding to the received setting data has already been stored in the setting data storing unit 240. The storing control unit 252 may search the setting data storing unit 240 for, e.g., names included in the received setting data.

When the setting data corresponding to the received setting data has not been stored in the setting data storing unit 240 (NO in step S703), in step S704, the storing control unit 252 stores the received setting data and openness data as new data in the setting data storing unit 240. The process then proceeds to step S706 described below.

When the setting data corresponding to the received setting data has been stored in the setting data storing unit 240 (YES in step S703), in step S705, the storing control unit 252 overwrites the corresponding setting data and openness data with the received setting data and openness data.

In step S706, the public list output unit 253 of the data registration unit 250 generates a list of setting data that are allowed to be opened, which is to be transmitted as the notification indicating that the setting data stored in the setting data storing unit 240 have been updated. Thus, the process ends.

The list generated in step S706 is output to the terminal devices 300 and 400 that communicate with the information processing device 200 in steps S511 and S512 illustrated in FIG. 5.

The notification output at this time may be information identifying, e.g., newly added setting data or overwritten setting data.

FIG. 8 is a flowchart illustrating a second example of the processes performed by the information processing device 200. FIG. 8 illustrates the details of the action of step S606 in FIG. 6. In other words, FIG. 8 illustrates the process performed by the data search unit 270 of the processing unit 230 of the information processing device 200.

The data search unit 270 performs the process illustrated in FIG. 8 each time the data search unit 270 receives the request for search for the setting data from any terminal device that communicates with the information processing device 200.

In step S801, the search request reception unit 271 of the data search unit 270 receives the request for search for the setting data from the terminal device 400. The request for search for the setting data may include the search parameters. The search parameters are search keys which are input by the user of the terminal device 400.

The request for search for the setting data may be transmitted from the terminal device 400 to the information processing device 200 in response to an operation instructing to search for the setting data on the search screen displayed on the terminal device 400. In response to a request for display of the search screen from the terminal device 400, the display control unit 220 may provide the instruction to the terminal device 400 to display the search screen, and the display control unit 440 of the terminal device 400 may display the search screen on the display.

A list of the setting data allowed to be opened, which is stored in the setting data storing unit 240, may be displayed on the search screen.

In step S802, in response to the request for search for the setting data, the search unit 272 of the data search unit 270 searches the setting data storing unit 240 based on the search parameters included in the request for search.

In step S803, the search unit 272 determines whether the setting data that matches the search parameters is stored in the setting data storing unit 240.

When the setting data that matches the search parameters is not stored in the setting data storing unit 240 (NO in step S803), in step S804, the search result output unit 273 of the data search unit 270 outputs to the terminal device 400 a notification indicating that the setting data that matches the search parameters is not stored. Thus, the process ends.

When the setting data that matches the search parameters is stored in the setting data storing unit 240 (YES in step S803), in step S805, the search result output unit 273 of the data search unit 270 extracts the setting data that matches the search parameters. In step S806, the search result output unit 273 outputs a list of the extracted setting data as a search result to the terminal device 400. Thus, the process ends.

FIG. 9 is a flowchart illustrating a third example of the processes performed by the information processing device 200. FIG. 9 illustrates the details of the action of step S611 in FIG. 6. In other words, FIG. 9 illustrates the process performed by the data output unit 260 of the processing unit 230 of the information processing device 200.

The data output unit 260 performs the process illustrated in FIG. 9 each time the data output unit 260 receives the request for acquisition of the setting data from any terminal device that communicates with the information processing device 200.

In step S901, the acquisition request reception unit 261 of the data output unit 260 receives the request for acquisition of the setting data from the terminal device 400. The request for acquisition of the setting data may include information identifying the setting data to be acquired. The information identifying the setting data may be, for example, the name of the setting data.

The request for acquisition of the setting data may be transmitted from the terminal device 400 to the information processing device 200 in response to an operation to acquire the setting data on an acquisition screen displayed on the terminal device 400.

In step S902, when the data output unit 260 receives the request for acquisition of the setting data, the acquisition availability determining unit 262 determines whether the setting data identified by the request for acquisition of the setting data is allowed to be acquired.

Specifically, the acquisition availability determining unit 262 refers to the openness data associated with the identified setting data in the setting data storing unit 240 to determine whether the identified setting data is allowed to be opened.

When the identified setting data is allowed to be opened (YES in step S902), in step S903, the setting data output unit 263 of the data output unit 260 acquires the identified setting data from the setting data storing unit 240 to output the identified setting data to the terminal device 400. Thus, the process ends.

When the identified setting data is prohibited to be opened (NO in step S902), in step S904, the setting data output unit 263 of the data output unit 260 outputs an error presenting the prohibition of acquisition of the setting data to the terminal device 400. Thus, the process ends.

In the present embodiment, as described above, determining by the acquisition availability determining unit 262 can prevent a user from acquiring setting data that is prohibited to be opened, for example, when the openness data corresponding to desired setting data selected from the list of the setting data that are allowed to be opened is updated, before the user executes a request for acquisition of the desired setting data, to the setting that prohibits the openness data to be opened.

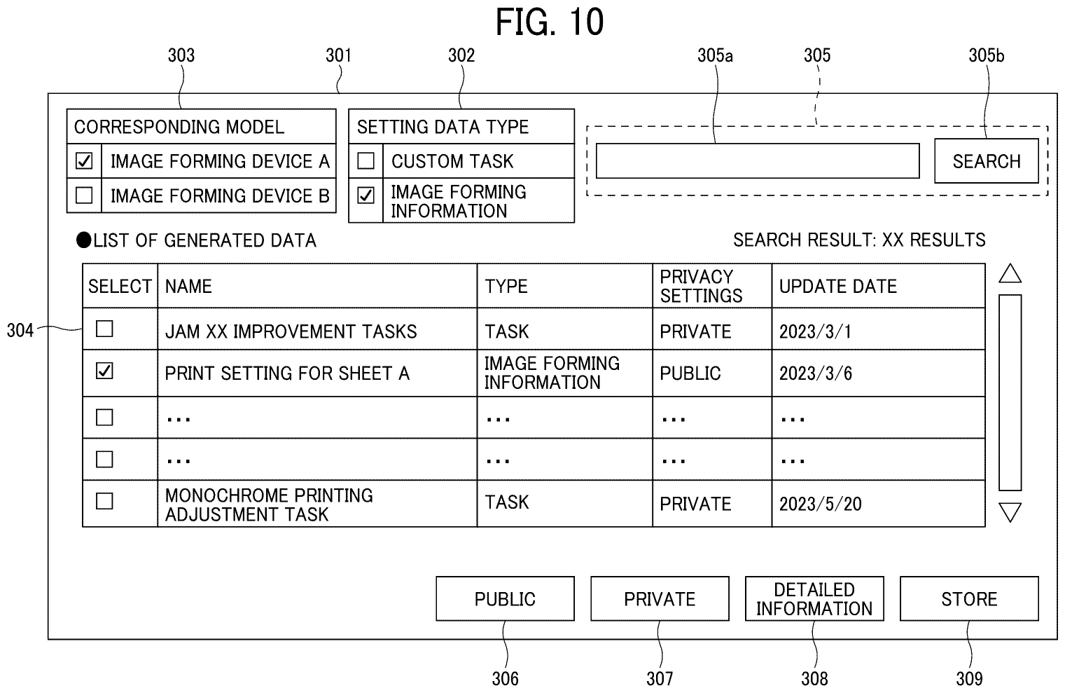

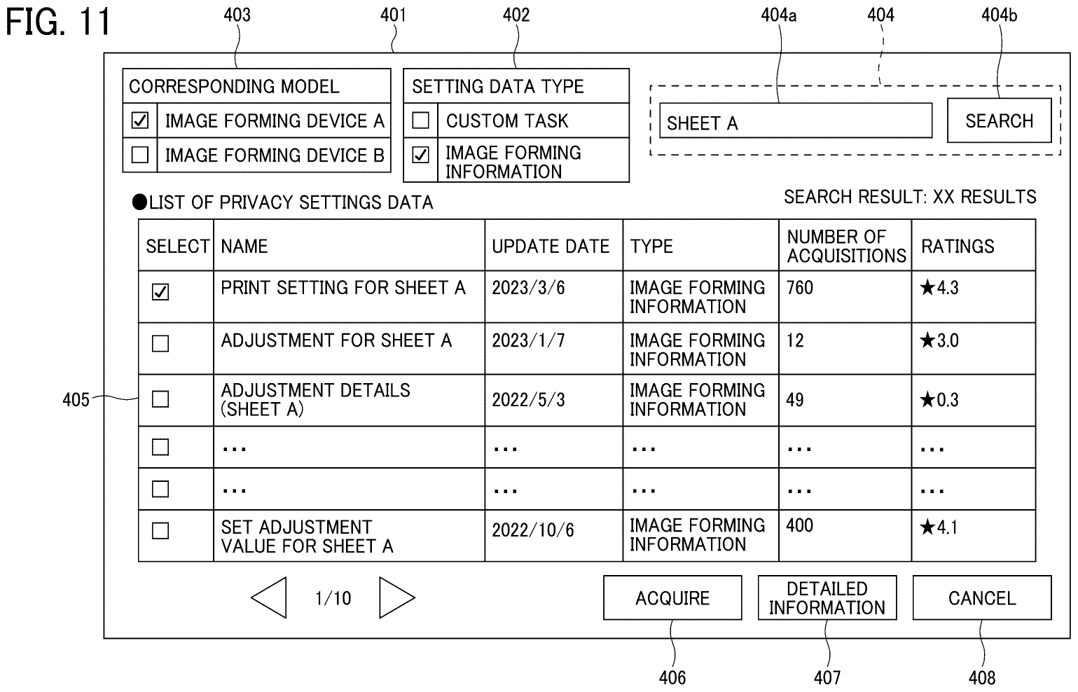

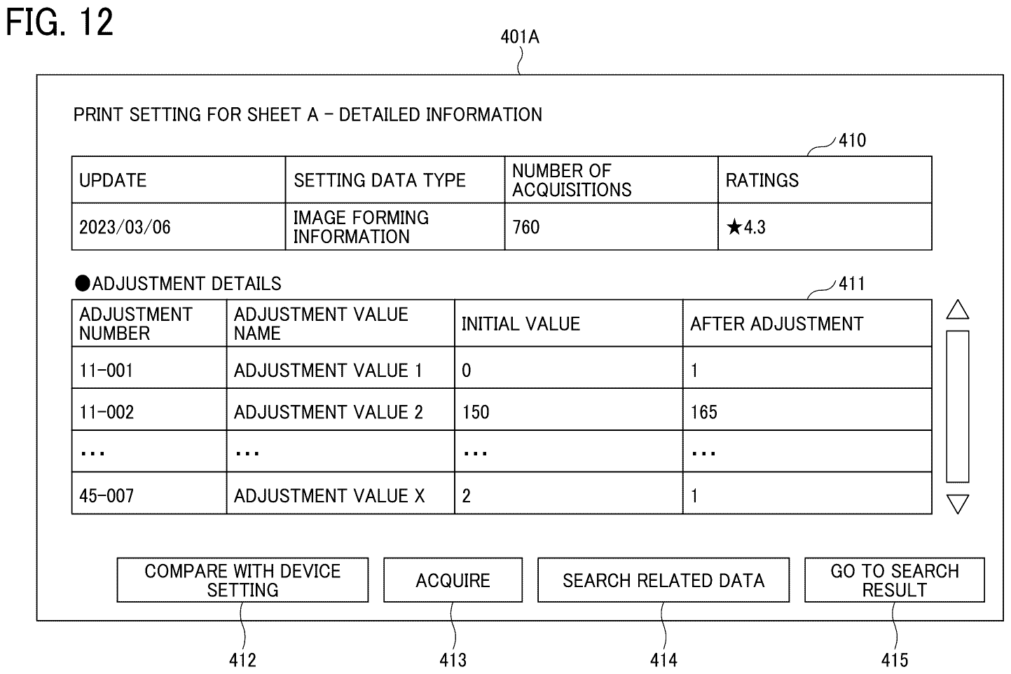

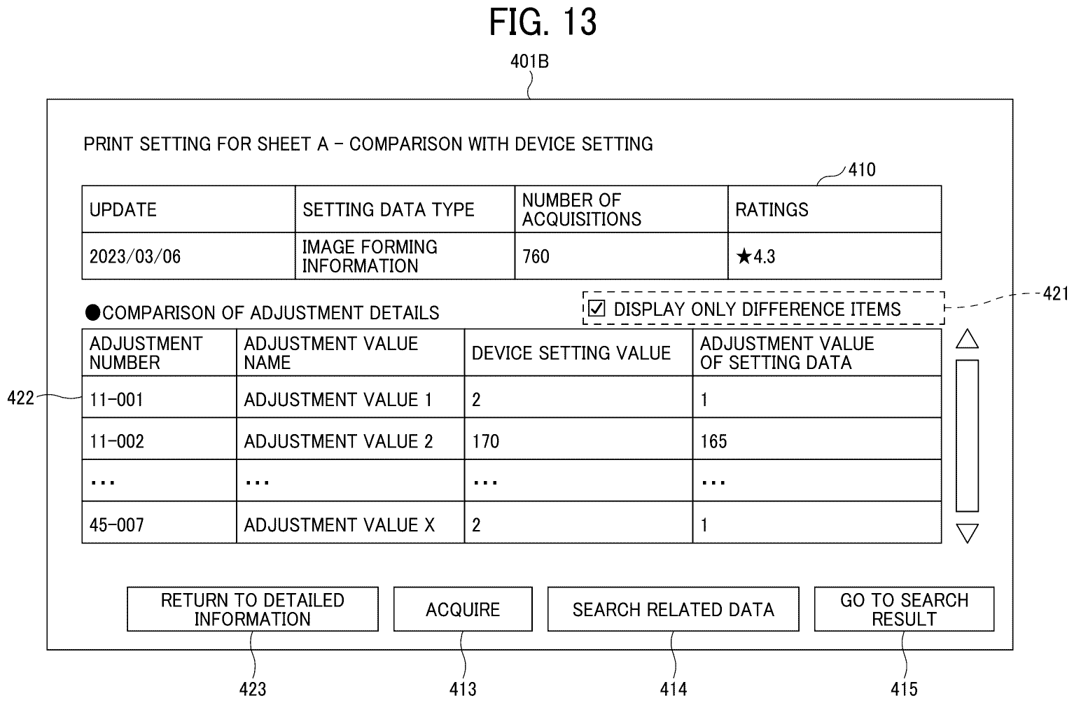

Referring to FIG. 10, FIG. 11, FIG. 12, and FIG. 13, various screens displayed on the terminal devices 300 and 400 are described.

FIG. 10 is a diagram illustrating an example of a registration screen displayed on the terminal device. A screen 301 illustrated in FIG. 10 is an example of the registration screen displayed on the terminal device 300 in step S507 in FIG. 5.

The screen 301 in FIG. 10 may be displayed on the terminal device 300 when the setting data already stored in the setting data storing unit 240 is updated.

The screen 301 includes display areas 302, 303, 304, and 305 and operation buttons 306, 307, 308, and 309.

The display area 302 displays information used for setting a type of the setting data. In the example of FIG. 10, “image forming information” is selected as the type of the setting data. When “custom task” is selected as the type of the setting data, the setting related to a specific process to be performed by the image forming device may be done.

The display area 303 displays information used for selecting a device corresponding to the setting data. In the example of FIG. 10, “image forming device A” is selected as the device to set with the setting data.

The display area 304 displays a list of setting data generated in the terminal device 300. In other words, the display area 304 displays a list of setting data generated by a user associated with the terminal device 300.

The display area 305 includes an input field 305a for inputting the search parameters and an operation button 305b for transmitting the request for search for the setting data. In the present embodiment, when the search parameters are input to the input field 305a and the operation button 305b is operated, setting data that matches the search parameters may be extracted from the list of the setting data displayed in the display area 304.

The operation button 306 is an operation button for setting the openness data corresponding to the setting data selected from the list displayed in the display area 304 to “public.” The operation button 307 is an operation button for setting the openness data corresponding to the setting data selected from the list displayed in the display area 304 to “private.”

In other words, the operation buttons 306 and 307 are operation components for setting whether to allow the setting data to be opened.

In FIG. 10, for example, it is assumed that the setting data with the name “print setting for sheet A” is selected from the list of the setting data displayed in the display area 304, the operation button 306 is operated, and the privacy settings of the setting data with the name “print setting for sheet A” is updated from “private” to “public.”

The operation button 308 is an operation button for displaying details of the setting data selected from the list displayed in the display area 304.

The operation button 309 is an operation button for transmitting the updated setting data and openness data to the information processing device 200. In the present embodiment, when the operation button 309 is operated on the screen 301, the privacy settings of the setting data with the name “print setting for sheet A” stored in the setting data storing unit 240 of the information processing device 200 is updated to “public.”

FIG. 11 is a diagram illustrating an example of a search result screen displayed on the terminal device. A screen 401 illustrated in FIG. 11 is displayed by the display control unit 440 of the terminal device 400 in step S608 in FIG. 6.

The screen 401 includes display areas 402, 403, 404, and 405 and operation buttons 406, 407, and 408.

The display area 402 displays information used for selecting the type of the setting data to be displayed in the display area 405. In the example in FIG. 11, “image forming information” is selected as the type of the setting data.

The display area 403 displays information used for selecting a device corresponding to the setting data to be displayed in the display area 405. In the example of FIG. 11, “image forming device A” is selected as the device to be set with the setting data.

The display area 404 includes an input field 404a for inputting the search key and an operation button 404b for transmitting the request for search for the setting data. In the present embodiment, when the search parameters are input to the input field 404a and the operation button 404b is operated, the request for search for the setting data whose type and corresponding device are selected in the display area 402 and the display area 403, respectively, and including the search key input in the input field 404a is transmitted to the information processing device 200.

In other words, the display areas 402, 403, and 404 on the screen 401 may function as input fields for inputting the search parameters to be transmitted to the information processing device 200.

The display area 405 displays a list of setting data searched according to the search parameters input in the display areas 402, 403, and 404. Therefore, in the example of FIG. 11, it can be seen that the display area 405 displays the result of searching the setting data storing unit 240 based on the search parameters “Sheet A.”

The operation button 406 is an operation button for transmitting the request for acquisition of the setting data (the identified setting data) selected from the list displayed in the display area 405 to the information processing device 200. The operation button 407 is an operation button for displaying detailed information of the setting data selected from the list displayed in the display area 405. The operation button 408 is an operation button for stopping the display of the screen 401.

In the present embodiment, when the setting data is selected in the display area 405 and the operation button 406 is operated, the request for acquisition of the selected setting data is transmitted to the information processing device 200.

In the present embodiment, when the operation button 407 is operated, the terminal device 400 switches from the screen 401 to a screen displaying details of the setting data selected from the list displayed in the display area 405.

The details of the setting data selected from the list displayed in the display area 405 may be displayed before the setting data is acquired. In this case, the user of the terminal device 400 can check the details of the setting data before acquiring the setting data.

FIG. 12 is a diagram illustrating an example of a detail screen displayed on the terminal device. A screen 401A illustrated in FIG. 12 is an example of a screen displaying the details of the setting data. The screen 401A is displayed on the terminal device 400 when the operation button 407 is operated on the screen 401 displayed on the terminal device 400.

The screen 401A includes display areas 410 and 411 and operation buttons 412, 413, 414, and 415.

The display area 410 displays the update date, the setting data type, the number of acquisitions, and the rating of the setting data selected on the screen 401. The display area 411 displays the adjustment details of the setting data selected on the screen 401.

The operation button 412 is an operation button for requesting the information processing device 200 to compare the setting data whose details are displayed on the screen 401A with the setting data set in the image forming device connected to the terminal device 400.

In the present embodiment, when the operation button 412 is operated on the screen 401A, the terminal device 400 acquires the setting data set in the image forming device connected to the terminal device 400 and transmits the setting data to the information processing device 200.

When the information processing device 200 receives the setting data, the comparison unit 280 compares the setting data received from the terminal device 400 with the setting data selected on the screen 401, and the display control unit 220 provides instructions to the terminal device 400 to display the comparison result.

More specifically, the comparison unit 280 may identify an item for which the adjustment details are different between the setting data received from the terminal device 400 and the setting data selected on the screen 401 and use the identified item as the comparison result.

The operation button 413 is an operation button for acquiring the setting data whose details are displayed on the screen 401A. The operation button 413 may be operated, for example, when the terminal device 400 has not acquired setting data.

The operation button 414 is an operation button for transmitting the request for search for the setting data related to the setting data whose details are displayed on the screen 401A to the information processing device 200.

The operation button 415 is an operation button for displaying the search result of the setting data related to the setting data whose details are displayed on the screen 401A.

In the present embodiment, when the operation button 414 is operated on the screen 401A, the terminal device 400 transmits the request for search for the setting data related to the setting data selected on the screen 401 to the information processing device 200. When the operation button 415 is operated on the screen 401A, the terminal device 400 transmits a request for acquisition of the related setting data to the information processing device 200.

When the information processing device 200 receives the request from the terminal device 400 for search for the setting data related to the selected setting data, the related data acquisition unit 290 searches the setting data storing unit 240 and acquires the related setting data.

For example, the related data acquisition unit 290 may search for the setting data whose adjustment details are similar to those of the setting data selected on the screen 401 as the related setting data. More specifically, the related data acquisition unit 290 may acquire the setting data whose item or target to be adjusted is similar to that of the selected setting data as the setting data related to the selected setting data. The setting data whose target to be adjusted is similar to that of the selected setting data is, for example, the setting data found by the search for setting data related to the setting data of a sheet attribute A based on the search parameters including the setting data related to the sheet attribute A.

As described above, in the present embodiment, the setting data related to the selected setting data can be displayed to the user of the terminal device 400 to assist the user in the acquisition of the desired setting data.

FIG. 13 is a diagram illustrating an example of a comparison result screen displayed on the terminal device. A screen 401B illustrated in FIG. 13 is an example of a screen displayed on the terminal device 400 in step S613 in FIG. 6. The screen 401B includes the comparison result output by the comparison unit 280. The screen 401B is displayed on the terminal device 400 when the operation button 412 is operated on the screen 401 displayed on the terminal device 400.

The screen 401B includes display areas 410, 421, and 422 and operation buttons 423, 413, 414, and 415.

The display area 421 displays information for selecting information to be displayed as the comparison result output by the comparison unit 280. Specifically, the display area 421 displays a check box, which allows the user to select whether items of the adjustment details to be displayed as the comparison result are to be limited to only items whose values are different from each other.

In the example in FIG. 13, the display area 421 indicates that the items of the adjustment details to be displayed as the comparison result are only the items whose values are different from each other.

The display area 422 displays the comparison result. In the example in FIG. 13, only the items whose values are different between the adjustment details included in the setting data received from the terminal device 400 and the adjustment details included in the setting data selected on the screen 401 are identified and displayed. In the display area 422, both the value in the setting data received from the terminal device 400 and the value in the setting data selected on the screen 401 are displayed for the identified items.

As described above, displaying the items whose values are different from each other together with the respective values enables the user of the terminal device 400 to ascertain the difference between the setting data currently set in the image forming device (an example of the device 20) and the setting data acquired from the information processing device 200.

In step S613 in FIG. 6, the two setting data to be compared may be displayed side by side.

In the present embodiment, the device used by each user of the plurality of terminal devices is described as an image forming device, and the setting data related to the device is described as setting data related to the image forming device. However, the device used by each user of the plurality of terminal devices is not limited to the image forming device.

Examples of the device used by each user of the plurality of terminal devices include a device for cleaning, a device for playing music, various air conditioners, various lighting devices, and various monitoring devices. The setting data may be the setting data specific to each device.

Alternatively, the device used by each user of the plurality of terminal devices may be, for example, a nursing care bed used in a nursing care facility. In such a case, the setting data may be the setting data for the nursing care bed.

In the present embodiment, the setting data generated by one user can be made available to other users for various types of devices, reducing the workload required to acquire the setting data.

### Modification

A description is given of a modified example in which the devices 10 and 20 are various devices other than image forming devices.

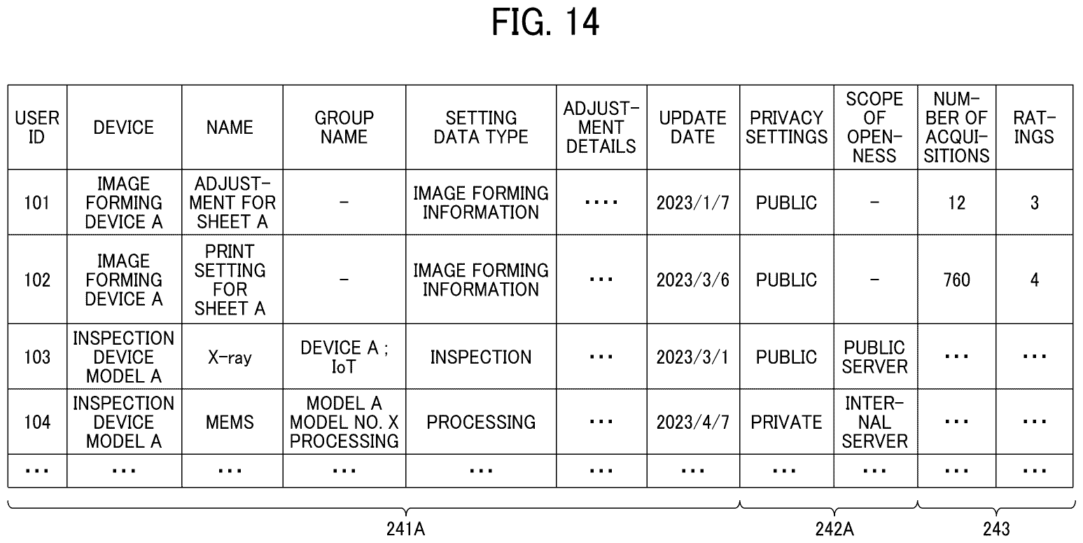

FIG. 14 is a diagram illustrating another example table stored in the setting data storing unit 240. The data stored in the setting data storing unit 240 illustrated in FIG. 14 includes setting data 241A, openness data 242A, and rating data 243.

The setting data 241A includes a group name as an information item in addition to the items illustrated in FIG. 3. The openness data 242A includes a scope of openness as an information item in addition to privacy settings.

The value of the item “group name” indicates the name of the group when the setting data are grouped. For example, in the example in FIG. 14, the setting data whose name is “X-ray” is classified into a group whose group name is “Model A; IoT.” As described above, by grouping the setting data for each device, the setting data can be searched based on, for example, the group name as search parameters.

The value of the item “scope of openness” indicates the scope within which the setting data is opened. More specifically, the value of the item “scope of openness” indicates the network within which the setting data is opened. When the value of the item “scope of openness” is “public server,” the setting data is opened on the Internet. When the value of the item “scope of openness” is “internal server,” the setting data is opened within an internal network such as the LAN.

In the example in FIG. 14, the group name and the scope of openness are set for the setting data whose value for the item “device/model” is “inspection device model A.”

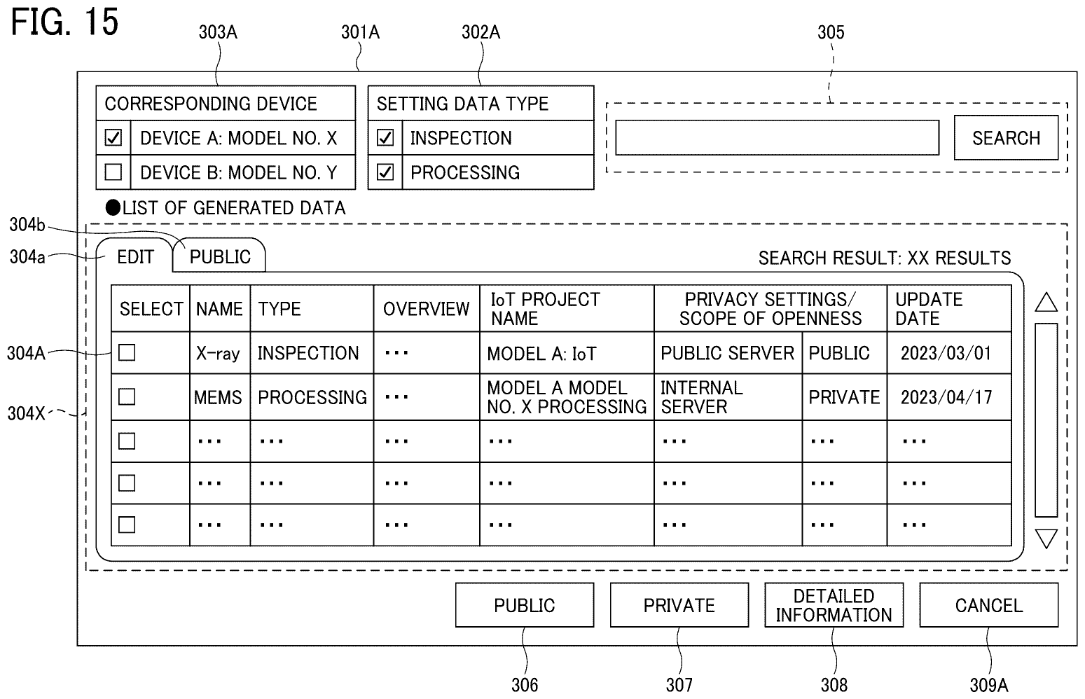

FIG. 15 is a diagram illustrating a first variation of the registration screen displayed on the terminal device. A screen 301A illustrated in FIG. 15 includes display areas 302A, 303A, 304X, and 305 and operation buttons 306, 307, 308, and 309A.

In the display area 302A, “inspection” is selected as the type of the setting data. When “processing” is selected as the type of the setting data, the setting data related to processing by the inspection device model A may be generated or edited.

The display area 303A displays information for selecting a device corresponding to the setting data.

In the example in FIG. 15, “inspection device model A” is selected as the device of the setting data.

The display area 304X displays a list of generated setting data and a list of setting data acquired from the information processing device 200.

The display area 304X includes tabs 304a and 304b. When the tab 304a is selected, the display area 304X displays a list of setting data generated in the terminal device 300, thereby enabling the user to edit the setting data generated. When the tab 304b is selected, a list of the setting data allowed to be opened is displayed.

In the example in FIG. 15, the tab 304a is selected in the display area 304X, and a list 304A of generated setting data is displayed.

When the setting data is selected from the list 304A of generated setting data on the screen 301 on the terminal device 300, the selected setting data can be edited.

In the example in FIG. 15, when the operation button 309A is operated, the selection of the tab 304a may be canceled.

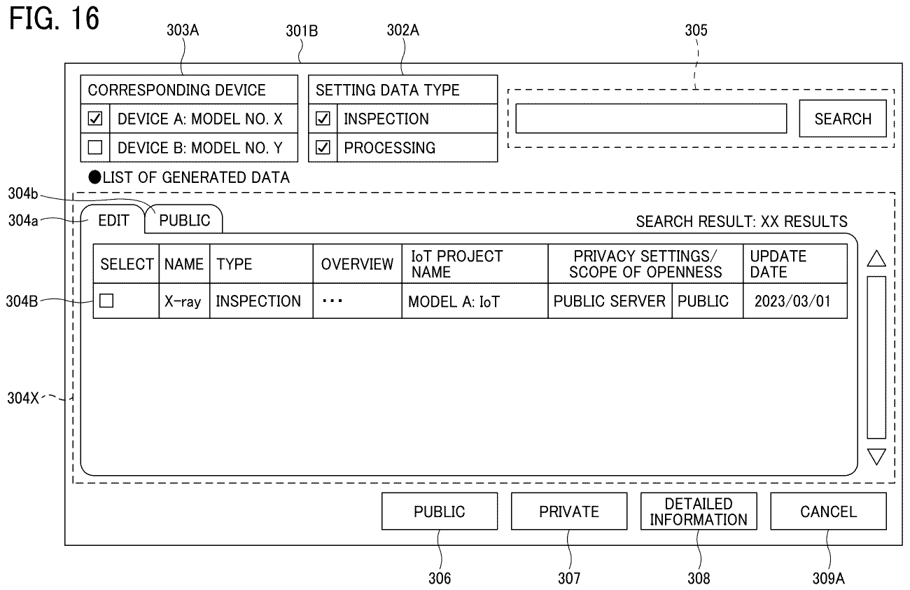

FIG. 16 is a diagram illustrating a second variation of the registration screen displayed on the terminal device. In a screen 301B illustrated in FIG. 16, the tab 304b is selected in the display area 304X, and a list 304B of the setting data allowed to be opened is displayed.

More specifically, a list of setting data allowed to be opened among the list 304A of the generated setting data illustrated in FIG. 15 is displayed as the list 304B in FIG. 16.

As described above, the user of the terminal device 300 can switch and browse between a list of the generated setting data and a list of the setting data allowed to be opened.

The devices described in the one or more embodiments are merely examples of multiple computing environments that implement the one or more embodiments disclosed herein.

In some embodiments, the information processing device 200 includes multiple computing devices such as a server cluster. The multiple computing devices are configured to communicate with one another through any type of communication link including a network and a shared memory and perform the processes disclosed herein. In substantially the same manner, for example, the information processing device 200 includes such multiple computing devices configured to communicate with one another.

Further, various units in the information processing device 200 can be configured to share the disclosed processes in various combinations. For example, a process executed by a particular unit may be executed by another unit of the information processing device 200. Similarly, a function of a particular unit may be performed by another unit of the information processing device 200.

The information processing device 200 may be any device having communication functions. Examples of the information processing device 200 include, but are not limited to, output devices such as a projector (PJ) and digital signage, a head-up display (HUD) device, an industrial machine, an imaging device, a sound collecting device, a medical device, a networked home appliance, an automobile (connected car), a laptop personal computer (PC), a mobile phone, a smartphone, a tablet terminal, a game console, a personal digital assistant (PDA), a digital camera, a wearable PC, and a desktop PC.

Aspects of the present disclosure are as follows.

According to Aspect 1, an information processing device includes a data registration unit, a public list output unit, and a setting data output unit. The data registration unit stores setting data related to setting of a device in association with openness data indicating whether the setting data is allowed to be opened to a plurality of users in a setting data storing unit.

The public list output unit outputs a list of setting data that are stored in association with the openness data indicating that the setting data is allowed to be opened among the setting data stored in the setting data storing unit to a terminal device.

The setting data output unit outputs setting data identified from the list to the setting data to be used for generating setting data of another device.

According to Aspect 2, the information processing device of Aspect 1 further includes a search unit, a search result output unit, and an acquisition availability determining unit. The search unit searches the setting data storing unit for the setting data that match search parameters in response to reception of the search parameters from the terminal device to obtain the list of setting data being based on a result of the search.

The acquisition availability determining unit determines whether the setting data identified from the list of the setting data is allowed to be opened.

When the setting data identified from the list of the setting data is allowed to be opened, the setting data output the setting data identified from the list to the terminal device, the setting data to be used for generating setting data of another device.

According to Aspect 3, in the information processing device of Aspect 1 or 2, the setting data stored in the setting data storing unit are generated by multiple different users.

According to Aspect 4, in the information processing device of any one of Aspects 1 to 3, the device includes an image forming device.

According to Aspect 5, the information processing device of any one of Aspects 1 to 4 further includes a comparison unit and a display control unit.

The comparison unit acquires setting data of the other device connected to the terminal device and compares the acquired setting data with the setting data identified from the list.

The display control unit causes the terminal device to display a result of comparison performed by the comparison unit.

According to Aspect 6, the information processing device of any one of Aspects 1 to 5 further includes a related data acquisition unit and a display control unit.

The related data acquisition unit acquires, from the setting data storing unit, setting data related to the setting data identified from the list.

The display control unit causes the terminal device to display the setting data related to the setting data identified from the list.

According to Aspect 7, the information processing device of any one of Aspects 1 to 6 further includes the setting data storing unit.

The setting data storing unit stores the setting data and the openness data in association.

According to Aspect 8, an information processing method executed by an information processing device includes storing, in a setting data storing unit, setting data related to setting of a device in association with openness data indicating whether the setting data is allowed to be opened to a plurality of users, outputting a list of setting data that are stored in association with the openness data indicating that the setting data is allowed to be opened among the setting data stored in the setting data storing unit to a terminal device, and outputting setting data identified from the list to the terminal device, the setting data to be used for generating setting data of another device.

According to Aspect 9, a non-transitory recording medium stores a plurality of instructions which, when executed by one or more processors, causes the one or more processors to perform a method. The method includes storing, in a setting data storing unit, setting data related to setting of a device in association with openness data indicating whether the setting data is allowed to be opened to a plurality of users, outputting a list of setting data that are stored in association with the openness data indicating that the setting data is allowed to be opened among the setting data stored in the setting data storing unit to a terminal device, and outputting setting data identified from the list to the terminal device, the setting data to be used for generating setting data of another device.

According to the one or more embodiments of the present disclosure, workload to acquire setting data is reduced.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing device comprising circuitry configured to:
store, in a memory, setting data related to setting of a device in association with openness data indicating whether the setting data is allowed to be opened to a plurality of users;
output a list of setting data that are stored in association with the openness data indicating that the setting data is allowed to be opened among the setting data stored in the memory to a terminal device; and
output setting data identified from the list to the terminal device, the setting data to be used for generating setting data of another device.

2. The information processing device according to claim 1,
wherein the circuitry is further configured to:
search the memory for the setting data that match search parameters in response to reception of the search parameters from the terminal device, the list of setting data being based on a result of the search;
determine whether the setting data identified from the list of the setting data is allowed to be opened; and
when the setting data identified from the list of the setting data is allowed to be opened, output the setting data identified from the list to the terminal device, the setting data to be used for generating setting data of another device.

3. The information processing device according to claim 1,
wherein the setting data stored in the memory are generated by multiple different users.

4. The information processing device according to claim 1,
wherein the device includes an image forming device.

5. The information processing device according to claim 1,
wherein the circuitry is further configured to:
acquire setting data of the other device connected to the terminal device and compare the acquired setting data with the setting data identified from the list; and
cause the terminal device to display a result of the comparison.

6. The information processing device according to claim 1,
wherein the circuitry is further configured to:
acquire, from the memory, setting data related to the setting data identified from the list; and
cause the terminal device to display the setting data related to the setting data identified from the list.

7. The information processing device according to claim 1, further comprising:
the memory that stores the setting data and the openness data in association.

8. An information processing method, comprising:
storing, in a memory, setting data related to setting of a device in association with openness data indicating whether the setting data is allowed to be opened to a plurality of users;
outputting a list of setting data that are stored in association with the openness data indicating that the setting data is allowed to be opened among the setting data stored in the memory to a terminal device; and
outputting setting data identified from the list to the terminal device, the setting data to be used for generating setting data of another device.

9. A non-transitory recording medium storing a plurality of instructions which, when executed by one or more processors, causes the one or more processors to perform a method, the method comprising:
storing, in a memory, setting data related to setting of a device in association with openness data indicating whether the setting data is allowed to be opened to a plurality of users;
outputting a list of setting data that are stored in association with the openness data indicating that the setting data is allowed to be opened among the setting data stored in the memory to a terminal device; and
outputting setting data identified from the list to the terminal device, the setting data to be used for generating setting data of another device.
